(19) United States
(12) Patent Application Publication
(10) Pub. No.: US 2013/0181812 A1
(43) Pub. Date: Jul. 18, 2013

(54) METHODS AND APPARATUS FOR DISPLAYING TRANSMITTED DATA

(71) Applicants: Benjamin I. Resner, Roxbury, MA (US); David L. Rose, Cambridge, MA (US); Nabeel Hyatt, Boston, MA (US); Robert Dredge, Somerville, MA (US); Pritesh V. Gandhi, Allston, MA (US)

(72) Inventors: Benjamin I. Resner, Roxbury, MA (US); David L. Rose, Cambridge, MA (US); Nabeel Hyatt, Boston, MA (US); Robert Dredge, Somerville, MA (US); Pritesh V. Gandhi, Allston, MA (US)

(21) Appl. No.: 13/775,476

(22) Filed: Feb. 25, 2013

Related U.S. Application Data
(63) Continuation of application No. 11/149,929, filed on Jun. 10, 2005, now abandoned.
Application No. 11/149,929 is a continuation-in-part of application No. 10/247,780, filed on Sep. 19, 2002, now abandoned.
(60) Provisional application No. 60/578,629, filed on Jun. 10, 2004.

(51) Int. Cl. G08B 5/22

(52) U.S. Cl. CPC G08B 5/225
USPC 340/7.55

(57) ABSTRACT

A reflective LCD, electronic ink or electrophoretic display panel presents a five day weather forecast representative of weather forecast data transmitted to the display location via a commercial paging service from a remote server. The server obtains forecast data from a commercial weather service, reformats selected data into compressed encoded data for efficient transmission in data packets simulcast to remote display devices via the paging network.

### CROSS REFERENCE TO RELATED APPLICATIONS

This application is a non-provisional of, and claims the benefit of the filing date of, U.S. Patent Application Ser. No. 60/578,629 filed on Jun. 10, 2004.

This application is also a continuation in part of, and claims the benefit of the filing date of, U.S. patent application Ser. No. 10/247,780 filed Sep. 19, 2002 and published as U.S. Patent Application Publication 2003/0076369 A1 on Apr. 24, 2003.

The disclosures of the above-identified applications are incorporated herein by reference.

### FIELD OF THE INVENTION

This invention relates to methods and apparatus for displaying data broadcast from a remote transmitter.

### BACKGROUND OF THE INVENTION

U.S. Patent Application Publication 2003/0076369 A1 describes a system for displaying data periodically broadcast by radio over a commercial paging network. At each receiving location, the transmitted data is presented in an “always-on” continuous display that changes only when new information is broadcast. The presentation of information using an “ambient” always-on display device provides a viewer with a constant awareness of information trends.

A centralized information server converts textual or quantitative data, typically obtained from an external source via the Internet, into a form suitable for presentation on the remotely located ambient displays or objects. The system may be used to display information on a variety of subjects of interest, such as current and forecast weather conditions, stock prices, etc., and may incorporate a selection mechanism that permits each user to select the kind of information displayed. A web interface may be used for selecting information to be broadcast from a remote server, and/or controls at the receiver may be used for selectively displaying different items of received data. The conversion, or translation, of the information obtained from an external source into a form suitable for display on the ambient display devices may conform to a set of data acquisition and conversion rules which may be fixed at the server, or may be modifiable by a user of the display. The translated data is preferably broadcast via a paging network or the like in compressed, encoded form to optimize the efficiency of its periodic transmission to the remote displays.

One form of display device described in the above-noted application publication employs an analog-type gauge having a hand that varies in angular or linear offset, or multiple hands that independently vary in angular or linear offset, in response to the received data. In another disclosed example, an object such as a globe or cube is illuminated in a color which is representative of a received data value; for example, the color of a globe may be change as the value of user's stock portfolio shifts between user-defined threshold levels, or a cube may glow red when wanner weather is forecast, glow blue when it is expected to turn colder, or pulsate in one of those colors when rain is forecast.

The information server receives information from an information source and translates the information to into a compressed data element optimized for presentation using a remote ambient display. The translation unit may perform the translation in accordance with translation rules programmable by a user of the ambient object, for example via a web-based interface, or via an electronic interface such as telephonic, wireless, and pager devices, or using controls forming part of the ambient display itself. The transmission system used to convey the compressed data elements to the receiving location is preferably a commercial paging network, but may take the form of some other telephone, wireless data, or wired data network, such as the Internet.

### SUMMARY OF THE INVENTION

The present invention takes the form of an improved ambient display device for displaying information transmitted from a remote location. The preferred embodiment of the invention includes a transmitter for simultaneously broadcasting an information bearing data signal to each of a plurality of receiving locations, and a display device located at each receiving location for simultaneously displaying a representation of the simulcast data at each location. For example, the data may provide a five-day weather forecast for the Boston area and be simultaneously displayed on numerous display devices configured to display the Boston area forecast.

The said display device consists of a receiver for detecting an information bearing signal broadcast by the transmitter to produce a received data signal, signal processing means coupled to said receiver for converting said received data signal into a plurality of control signals, and a mosaic of separately controlled visual elements whose appearance controlled by one of said control signals.

In one arrangement, the transmitter and receiver respectively send and receive data packets via a radio transmission link which may be provided by an available commercial paging system.

The mosaic of separately controlled visual elements is preferably formed by a flat panel display, such an LCD, electronic ink or electrophoretic display panel. The individual visual elements of the display are energized or deenergized by the control signals. The reflectivity or visual appearance of each of the visual elements of display panel is controlled by one of said control signals, providing a display device that does not require a source of illumination and can accordingly be operated continuously consuming little electrical energy.

The display device may also advantageously incorporate a memory for storing data signals transmitted at different times, and may produce different screen displays at the request of a user based upon the accumulated data stored in the memory.

The display device can also be dynamically upgraded to a custom “premium” signal where the information generating server dedicates a portion of bandwidth to that particular device, and creates a transmission packet for exclusive decoding by a single device or a group of cloned devices.

### BRIEF DESCRIPTION OF THE DRAWINGS

In the detailed description which follows, frequent reference will be made to the attached drawings, in which:

FIG. 1 is schematic block diagram which depicts an information display system of the type contemplated by the invention;

FIG. 2 is a plan view showing the location of the visual elements of a flat panel display panel for displaying weather forecast information in accordance with the invention;

FIG. 3 is a plan view showing the panel of FIG. 2 with selected elements being activated by an example weather forecast data received from a remote source;

FIG. 4 is a schematic block diagram illustrating the operation of a programmable information server;

FIG. 5 is a plan view of a alternative flat panel display of a nine day weather forecast;

FIG. 6 is a plan view of a flat panel display showing sailing conditions at three hour intervals;

FIG. 7 is a plan view showing a display of an iconic representation of current weather conditions and four smaller areas showing conditions over the next four days;

FIG. 8 is a plan view of an alternative five day forecast display;

FIG. 9 is a schematic representation of the simulcast zones employed by the paging network operator; and

FIG. 10 is a plan view of a display showing regional traffic conditions.

### DETAILED DESCRIPTION

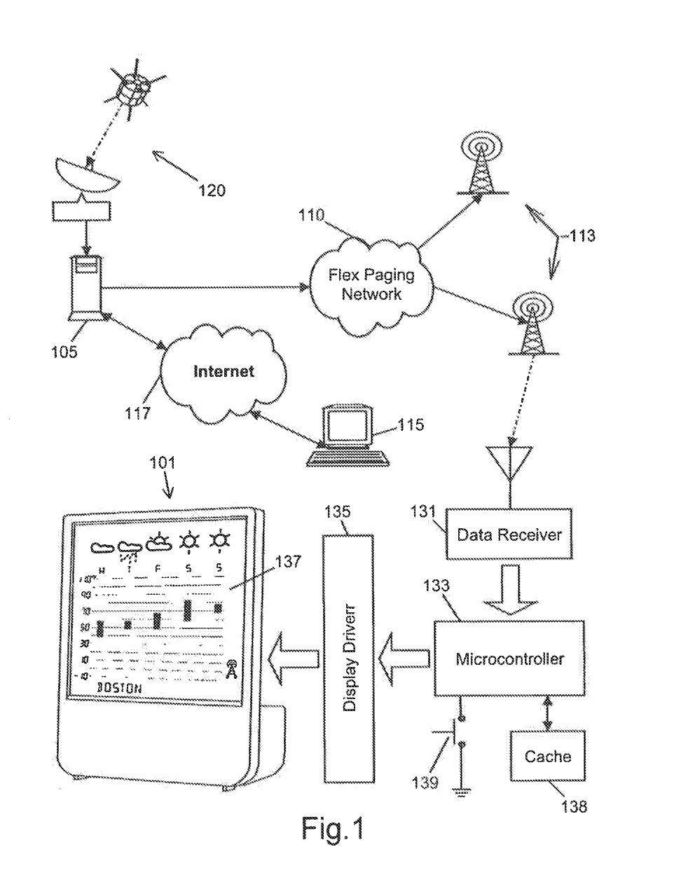

An illustrative system which employs the principles of the invention to provide an continuous ambient display of forecast weather conditions at a particular location is seen in FIG. 1 The system displays a five-day weather forecast on a battery-operated, liquid crystal display panel called a “Weather Glass” seen at 101 which can be placed on a desk or shelf. The reflective LCD display is always on so that the five day weather forecast is always visible. Each unit has a unique serial number that allows for targeted (narrowcast) broadcasts for various purposes including over-the-air reprogramming such that the device will additionally or exclusively decode data packets created exclusively for this specific or class of devices. This allows user to customize both the presentation of data, and the actual data display displayed on his or her device.

The weather forecast data is broadcast to the display from a remote server 105 via a commercial paging network 110. The weather data signal is simulcast from a transmission antenna illustrated at 113, one of which is within radio range of the display unit 101. The weather data itself may be obtained from a commercial weather service such those provided by AccuWeather, Inc. of State College, Pa.; The Weather Channel Interactive, Inc. of Atlanta, Ga.; and the National Weather Service of Silver Spring, Md.

These and other sources of weather forecast data are illustrated by the satellite acquisition system seen at 120 in FIG. 1. At the server 105, the weather forecast data is encoded into “micropackets” and multiple micropackets are assembled for efficient delivery via a FIex™ type wireless pager system 110. The encoded data packets can range in size between a single byte of data to several hundred bytes. The time-slice format used to transmit pages place an upper limit on the size of a paging packet. While there is no lower limit on packet size, small packets are inefficient to deliver. For example, in Flex™ paging systems, the overhead to transmit a single data packet ranges from 8 to 16 bytes. Therefore, less bandwidth is used to send a single 100-byte data packet, than to send 20 5-byte data packets. Because the amount of data needed to provide a full weather forecast for a given location is approximately 25 bytes, several micropackets each of which provides forecast data for a different location may be aggregated into a single packet, and each remote ambient device 101 is configured to listen to, or receive, a specified segment of that packet including the expected micropacket of data. Additionally, smaller micropackets of a single byte can be used to update only the current temperature. The entire forecast does not need to be updated with the same periodicity as the current temperature because the above cited weather forecasting organizations only update their forecasts a small number of times per day. By dynamically sizing the update to only include data that has changed, even greater bandwidth savings can be achieved. Aggregation of the micropackets into packets of data for transmission is much more efficient than transmitting individual data packets to each individual remote ambient device. More sophisticated aggregation and scheduling approaches can, for example, take into account additional parameters such as how much the data has changed, how urgently the data needs to be updated, what level of service the user is entitled to, and what type of coverage is available to the user. See the above noted U.S. Patent Application Publication 2003/0076369-A1 for additional details.

As also discussed in detail in Publication 2003/0076369-A1, the server 105 may provide a web interface that permits a user or administrator to configure the content and format of the data broadcast to the remote display units for different applications and special needs of individual users. The user or administrator may configure the system using a conventional web browser program executing on a PC as illustrated at 115 which is connected via the Internet 117 to a web server process that runs on the server 105.

Each display unit 101 incorporates a data receiver 131 for receiving the wireless radio broadcast signal from a nearby transmission antenna 113 and a microcontroller 133 for processing the incoming packetized data signals from the receiver 131 and converting those packetized signals into control signals that are delivered via display driver circuitry 135 to an LCD display panel 137. The microcontroller 133 may accumulate data transmitted at different times in a cache store 138 which may hold enough weather forecast data to permit several different display modes to be selected at the display panel using a pushbutton 139.

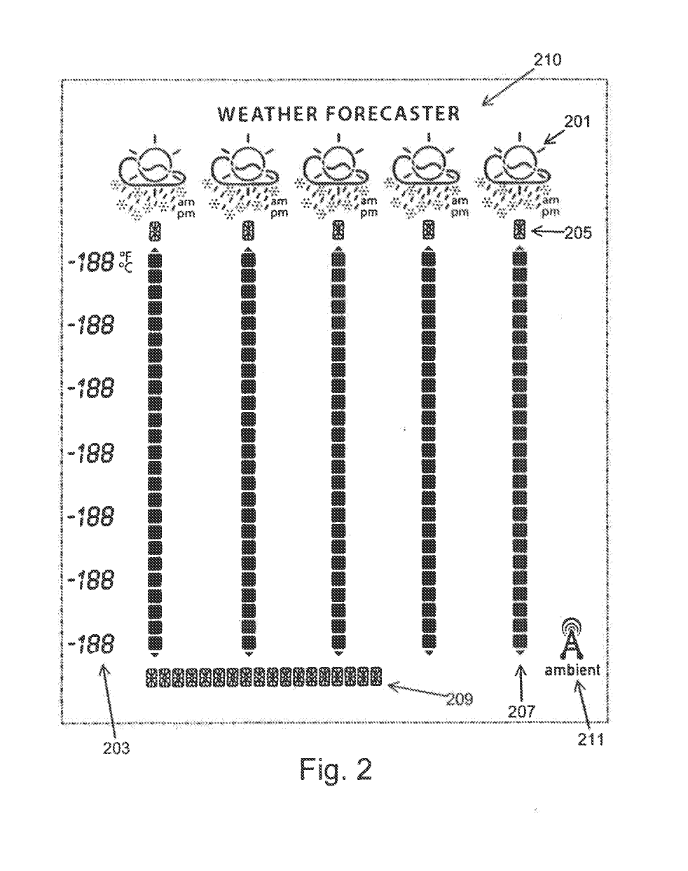

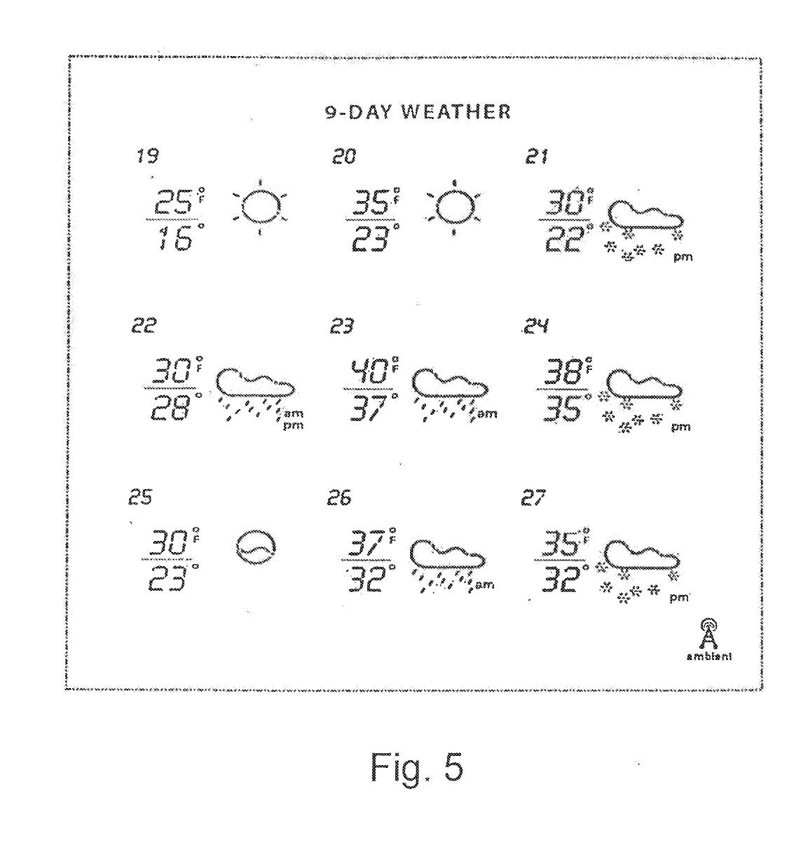

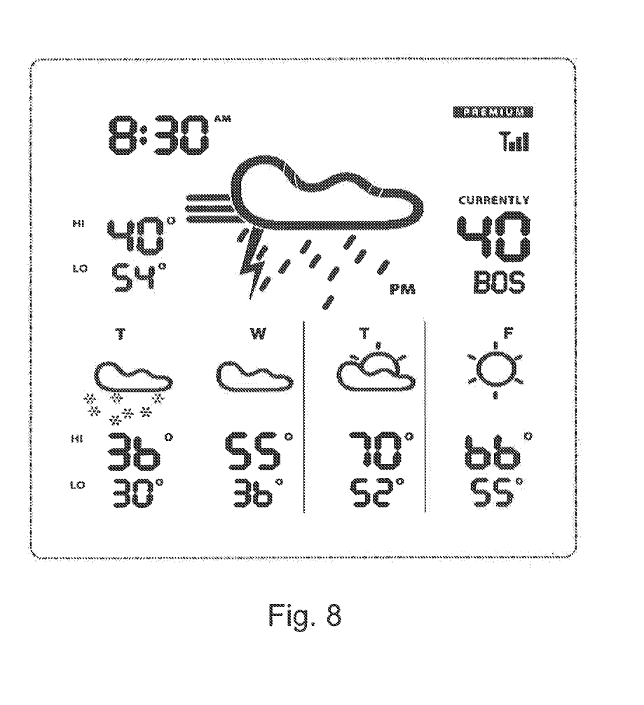

The transmission system, as described above, provides a continuous display of information. At any given time, some of the displayed information may change very infrequently (such as the label “9 Day Weather” at the top of FIG. 5, to be discussed below), whereas other portions of the display may change only on a daily basis (such as the calendar day numerals of FIG. 5), and still other portions of a display may change often (such as the current temperature of “40°” in the display seen in FIG. 8). By sending data defining the new state of only those portions of the display that change, when they change, a significant bandwidth saving is achieved. Note also that, in addition to data that is displayed, data may also be periodically sent or updated that is used for mapping transmitted data to display formats (such as translating a one-of-seven code into a set of day designating letters as seen at 205 in FIG. 2). In addition, the transmission facility may be used to download executable code or over-the-air (OTA) reprogramming instructions to a specific device on an as needed basis. Thus, when a user selects a new service or display format using a Web interface or by some other means, new data and/or software may be directed to that device. In this way, new screen layouts, new symbols or icons, and the like may be transmitted to a specific device to alter its function whenever the user changes his preferences, or changes to a different service (perhaps a premium service which is billed at a different subscription rate), or a when an existing service is updated or improved (perhaps transparently to the user). As described in the above noted U.S. Patent Application Publication 2003/0076369-A1, a sub-addressing operation may be used to transmit specific data to a specific display device.

Each display device may be assigned a unique ID which is stored locally on the device. Broadcast packets preceded by this unique ID are decoded by the device, while other devices with different unique ID are discarded. By transmitting a particular service code or codes to a particular device or group of cloned devices which defines the kind of service that device subscribes to (e.g. a nine-day forecast for Boston), the display device can be conditioned to thereafter look for and respond to packets relating to that designated service. The transmitted data to which the device responds include not only displayable data, but also mapping data and software which determine how the device renders the received data on the display screen.

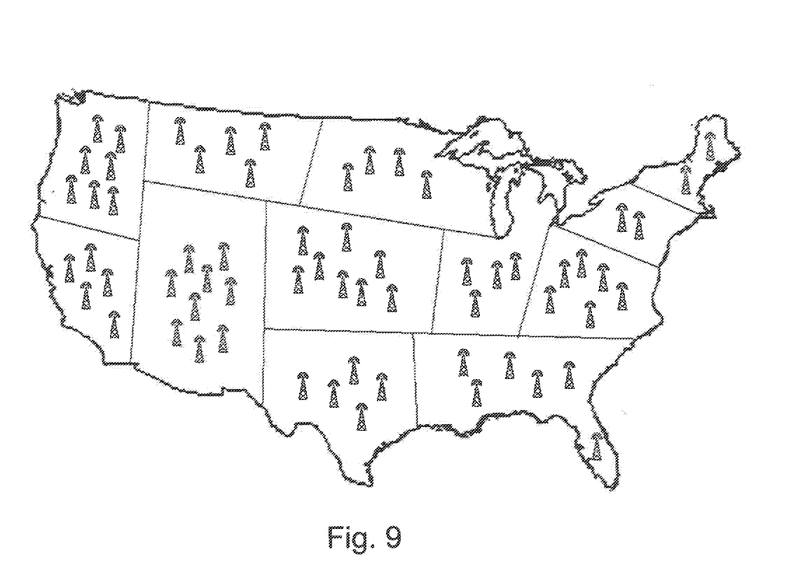

Note that individually addressing each device can also be accomplished by assigning each device a unique “capcode” which is obtained from the paging network operator. In some situations this may have certain advantages for battery optimization, but it requires greater coordination between Ambient Devices and the paging network operator. Note also that any scheme which uses an explicit address (either subaddressing or unique capcode) to send a packet a particular device or devices is only used for the reprogram instructions and code, which are typically infrequent and in practice are a very small percentage of the bandwidth budget. The actual data is broadcast using a “micropacket” scheme described above and in U.S. Patent Application Publication 2003/0076369-A1. This micropacket scheme is much more efficient at transmitting small amounts of data typically employed with the devices described in this application. The Flex™ paging system which may be used to transmit data to the devices is divided by the paging network operator into 63 “simulcast zones”. In FIG. 9, each shaded region is a simulcast zone, which is an aggregation of one or more time synchronized antennae that broadcast identical data to all devices in that region. In this way, a single simulcast zone acts like a large distributed antenna, which greatly increases coverage by filling in dead spots. Simulcast zones are arranged such that there is minimal overlap between adjacent simulcast zones. This ensures that any given device only receives signal from a single simulcast zone.

It is important to note that in practice there are many more simulcast zones than displayed in FIG. 9. Furthermore, in practice, simulcast zones do not perfect abut each other, but are often separated by areas of no coverage.

By sending different data to the same address in each of the 63 simulcast zones, a given device can display different data depending on its location. This allows a device to automatically switch between Boston weather when in Boston, and San Francisco weather when in San Francisco. Unlike a GPS, the device does not actually “know” where it is located, it is simply responding to the information signal it is receiving, which is unique for each simulcast zone. Devices located on boundaries between simulcast zones will alternate between simulcast zones depending on which data set was received most recently, and require additional instructions to decode correct location. In practice this is very rare.

In addition to weather, there are other data sources that are appropriate for regionalized broadcasting. This includes such things as local energy pricing, pollution/pollen levels, and news headlines. For people who suffer from allergies, an indication of the pollen level (typically based on data provided a weather service) may be displayed by itself or with weather forecast data. News headlines which vary from region to region to reflect local news may be displayed as text characters.

Companies such as Traffic.com of Wayne, Pa. (http://www.traffic.com) collect and aggregate highway traffic information from major metropolitan areas. This data is then displayed on a web page or resold to third parties. Regional traffic conditions may be displayed to advantage on an device of the type contemplated by the present invention in the same way that regional weather information is displayed. Local traffic information is broadcast in each pager simulcast zone allowing a device to receive regional traffic information without any configuration. Just like weather, a traffic device receives Boston traffic in Boston, and San Francisco traffic in San Francisco. Additionally, just like weather, the user can visit a website and configure their specific device. For instance, the device can be programmed to display aggregate travel time for a specific route or route segment. This provides more specificity than overall traffic flow along a potentially long stretch of route. This aggregation calculation can either be done by the server and sent as a custom data packet, or locally by the device by picking and choosing between existing broadcast traffic information.

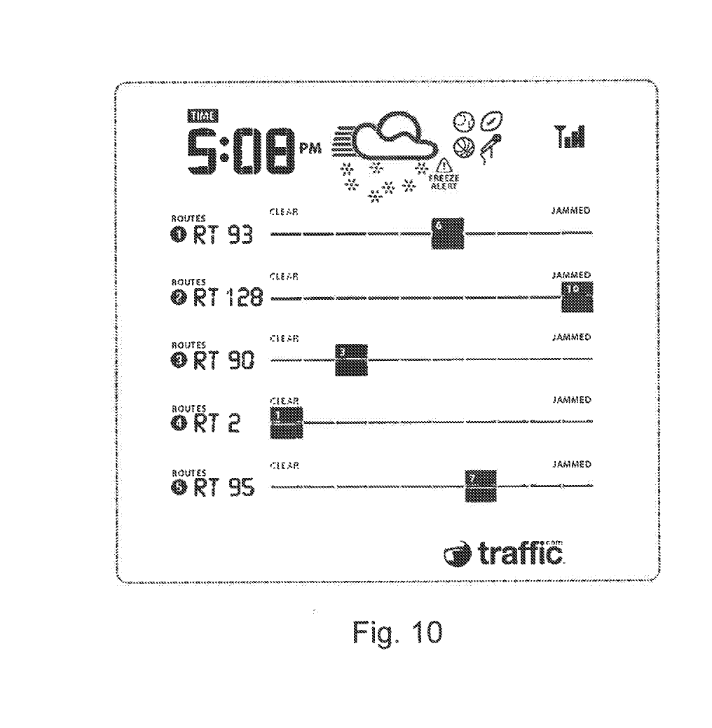

A display that may be used to indicate traffic conditions is shown in FIG. 10. The device which produces such a traffic display may also displays weather conditions, as well as information about sporting events—both of which can affect upcoming traffic conditions. Similar to the traffic data, the exact behavior of these icons can be customized by visiting a configuration website.

The preferred embodiment of the invention described here employs a liquid crystal display panel which provides a high resolution display from a small amount of input data and consumes very little power, thus providing long battery life even though the display is continuously available to the viewer. It should be understood, however, that other forms of display panels may also be used to advantage to implement the invention. Alternative displays include E-Ink™ electronic ink displays and Sipix™ electronic paper displays which, along with LCD displays, are discussed briefly below

E-Ink™ electronic ink displays available from E-Ink Corporation of Cambridge, Mass. The principal components of electronic ink are millions of tiny microcapsules, about the diameter of a human hair. In one incarnation, each microcapsule contains positively charged white particles and negatively charged black particles suspended in a clear fluid. When a negative electric field is applied, the white particles move to the top of the microcapsule where they become visible to the user. This makes the surface appear white at that spot. At the same time, an opposite electric field pulls the black particles to the bottom of the microcapsules where they are hidden. By reversing this process, the black particles appear at the top of the capsule, which now makes the surface appear dark at that spot. Electronic ink retains the superior viewing characteristics of paper, including high contrast, wide viewing angle, and bright paper-white background. It can be printed on almost any surface, from plastic to metal to paper, and can be coated over large areas cheaply. Electronic ink uses is a real power miser. It displays an image even when the power is turned off and it's even legible in low light reducing the need for a backlight. This can significantly extend battery life for portable devices. E Ink electronic displays and their applications are described in numerous U.S. patents and published applications, including E Ink electronic ink is described in numerous U.S. patents and application assigned to E Ink Corporation, including U.S. Pat. No. 6,413,790 issued to Duthaler, et al. on Jul. 2, 2002 entitled “Preferred methods for producing electrical circuit elements used to control an electronic display.”

Electrophoretic Displays (EPDs), non-emissive display devices based on charged particles in a colored fluid. EPDs are hi-stable, exhibit low power consumption, and provide a wide viewing angle and have been successfully used in many applications, including electronic signs, electronic shelf labels, smart cards, cell phones, watches and e-books. EPDs marketed by Sipix of Sipix Imaging, Inc. of Fremont, Calif. are ultra light, ultra thin, use a low operation voltage and extremely low power consumption, provide very wide view angle, flexible size, high contrast, fast switching rate, long-term bi-stability, high resolution, and uniform image characteristics. Sipix EPDs are described in numerous U.S. patents and applications assigned to Sipix Imaging, Inc., including U.S. Pat. No. 6,859,302 issued to Liang, et al. on Feb. 22, 2005 entitled “Electrophoretic display and novel process for its manufacture.”

A liquid crystal display (LCD) glass panel has transparent electrical conductors plated onto each side of the glass in contact with a liquid crystal fluid contained within the panel. These transparent conductors are used as electrodes. When an appropriate electrical drive voltage is applied to the cell electrodes, an electric field is set up across the liquid crystal fluid. The liquid crystal molecules then rotate into alignment with in the direction of the electric field.

LCDs have the capability to produce both positive and negative images. A positive image is defined to be a dark image on a light background. In a positive image display, the liquid crystal is sandwiched between front and rear polarizers that are perpendicular to each other. Unenergized pixels and the background area transmit the light and energized pixels obstruct the light creating dark images on the light background. A negative image is a light image on a dark background. In this type of display, the front and rear polarizers are aligned to each other. Unenergized pixels and the background inhibit light from passing through the display. Energized pixels allow the light to pass creating a light image on a dark background.

There are essentially three types of viewing modes for a LCD: reflective, transmissive, and transflective.

Typically, reflective displays use only positive images. For pixels that are ON, the light never reaches the reflector and therefore does not return to the observer. Reflective displays lend themselves to battery powered applications because the images are created using ambient light sources. These displays are very bright under proper lighting conditions, with excellent contrast, and have a wide viewing angle.

Transmissive displays do not reflect light back to the observer. Instead, they rely upon a light source behind the panel to create images. These displays are very good for very low light level conditions. They are very poor when used in direct sunlight because the sunlight swamps out the backlighting.

The third type of display is called transflective. It reflects some of the ambient light back to the observer while also allowing backlighting. Transflective displays are very good for applications which have varying light conditions which must operate during the day in bright light, but must also operate at night. Transflective displays have lower contrast ratios than reflective displays because some of the light passes through the reflector.

An introductory description of the construction, features, and use of liquid crystal displays and the manner in which they may be driven by microcontrollers is presented in “LCD Fundamentals using PIC16C92X Microcontrollers,” Datasheet No. DS00658A, 1997, Microchip Technology, Inc., and in U.S. Pat. No. 5,861,861 issued to Nolan, et al. on Jan. 19, 1999 entitled “Microcontroller chip with integrated LCD control module and switched capacitor driver circuit,” the disclosure of which is incorporated herein by reference. The foregoing Nolan et al. patent describes a method of providing multiple discrete regulated voltage levels for driving a liquid crystal display (LCD) from an LCD module integrated in a microcontroller chip, wherein the LCD display operates in conjunction with a system external to the chip being controlled by the microcontroller and the microcontroller supplies operating functions including internal clock signals to the LCD module for maintaining the operational timing of the LCD display. The on-chip driver circuitry provides discrete regulated voltage levels as multiples of a base voltage level and switching means for selectively applying the discrete regulated voltage levels to activate individual pixel locations in the LCD display. Thus, the functions of the microcontroller 132 and the display driver circuitry 135 can be made available on a single integrated circuit.

An illustrative panel display for presenting a five day weather forecast is depicted in FIG. 2. The panel the following active elements:
(a) a top row of five weather condition icon elements, one of which is indicated at 201;
(b) a temperature scale indicated at 203 which forms a column of seven numerals;
(c) a day of the week row below at 205 consisting of 5 alphabetic characters;
(d) a set of five vertical rows of 25 temperature dots, the right-most vertical row being indicated at 207; and
(e) a text label for displaying up to 18 characters seen at 209.

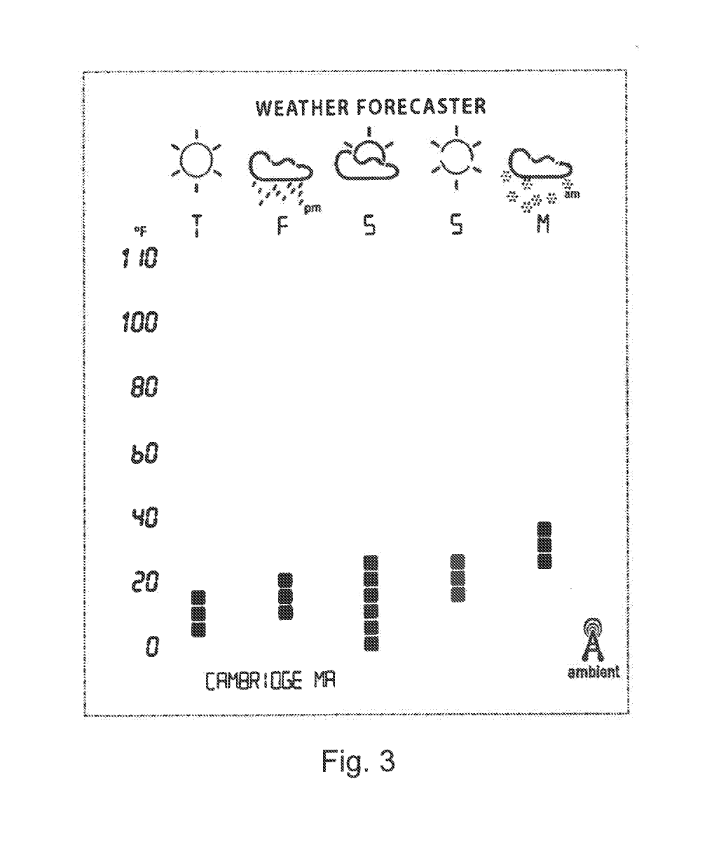

In addition, the panel may include fixed indicia such as the label “WEATHER FORECASTER” at 210 and a trademark logo for “Ambient” seen at 211. The logo 211 includes the active semicircle elements indicative of radiation near the top of the radio-tower-like “A” which may continuously pulsate to indicate to the user that the device is operating. Otherwise, except when the display changes when new forecast data is received, the display is static and always visible. FIG. 3 shows an illustrative display that can be provided by the elements seen in FIG. 2.

The amount of data needed to uniquely specify a given screen may be calculated as follows:

First, each of the five icons 201 may represent one the following 16 states (encoded as four bits), requiring at total of 20 bits encodable as three bytes.

TABLE 1
Weather condition states

| Code | State |
|---|---|
| 0000: | blank |
| 0001 | Sunny |
| 0010: | Partly Cloudy |
| 0011 | Partly Cloudy Rain |
| 0100 | Partly Cloudy Snow |
| 0101 | Partly Cloudy Rain AM |
| 0110 | Partly Cloudy Snow AM |
| 0111 | Partly Cloudy Rain PM |
| 1000 | Partly Cloudy Snow PM |
| 1001 | Cloudy |
| 1010 | Cloudy Rain |
| 1011 | Cloudy Snow |
| 1100 | Cloudy Rain AM |
| 1101 | Cloudy Snow AM |
| 1110 | Cloudy Rain PM |
| 1111 | Cloudy Snow PM |

Note that these sixteen states are displayed by displaying combinations of the following visible elements, each of which consists of a pattern of segments which are rendered visible when the electrodes which form those segments are energized: (1) upper portion of sun icon, (2) lower portion of sun icon, (3) cloud icon, (4) rain icon, (5) snow icon, (6) “AM” letters, and (7) “PM” letters. Note that these icons could be directly controlled by 7 transmitted bits (for each of the five icons), or as noted above, by four bits for the sixteen possible states. Since the most valuable resource is the bandwidth of the broadcast signal, it is preferable to send 20 bits (4 bits for each of the five icons), and employ the microcontroller 133 to translate each four bit value into the corresponding seven control signal states applied to the LCD electrodes.

Using similar techniques, the data needed for a complete five day forecast can be encoded as follows:

TABLE 2
Five Day Forecast Encoding

| Element | Bytes |
|---|---|
| (a) five weather condition icon elements201 | 3 |
| (b) a temperature 203 | 2 |
| (c) a day of the week letters | 1 |
| (d) vertical rows of 25 temperature dots | 6 |
| (e) a text label | 13 |
| Total | 25 |

Thus, four different 5 day forecasts for four different locations can be encoded into a single 100 byte packet for broadcast transmission. It is important to note the mapping between the incoming signal and the graphical display is not necessarily one-to-one. For instance, seven segment displays are used to display the numbers “0”, “1”, “2”, “3”, “4”, “5”, “6”, “7”, “8”, “9”. Thus, while a seven segment element is capable of 128 combinations, only ten of these combinations are meaningful. Therefore, it is much more efficient to transmit a one-of-ten choice (which can be accomplished with 4 bits), and use a local character mapping algorithm on the display device to expand this one-often choice into a one-of-128 choice which specifies the on/off state of the seven segments used for the character display. Transmitting a one-of-128 choice allows the seven segment display to render all combinations of individual segments, but for most applications, this is not desirable. Similarly, uppercase text can be displayed with a 14 character display. This yields 16384 combinations, but only the 26 letters are the alphabet are meaningful. In practice, a local character generator is used to translate from a 7-byte ASCII character set to the 14-byte character display.

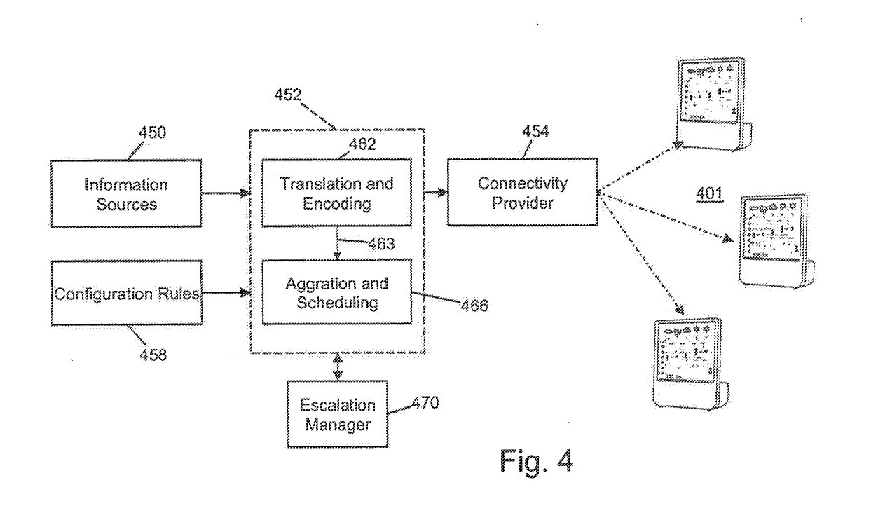

The functions performed by the server seen at 105 in FIG. 1 are illustrated in FIG. 4. An information server 452 receives and manages information in the form of digital data from an external information source 450 or a plurality of such sources. For example, such data may comprise data related to traffic, stock performance, weather, pollen, email accumulation, sports scores, status of a family member, status of a home alarm, and the like. A growing number of companies that make such information available on the Web as Web Services which conform to an interface standard that provides programmatic connections to be easily established between an executing application program and remote resources which provide data. Web services are described in the World Wide Web Consortium Note entitled “Web Services Architecture” which is available at http://www.w3.org/TR/ws-arch/.

A database manager 470 at the server 452 utilizes administrator tools to control access to the server, associated Web site implemented by an associated web server, and data contained therein which may be stored in a connected database. The database manger further performs maintenance tasks such as billing, load balancing, and caching. The administrator tools are further capable of providing statistics on user preferences and click-through behavior. The nature of the translation performed by the translation and encoding unit 462 conforms to rules illustrated at 458 that may be configured, for example by a user of the ambient display device or by the manager of the information server. This configuration may be performed using a Web interface to a remotely located PC as illustrated at 115 and 117 in FIG. 1.

Following translation and encoding of the data at 462, the data is transferred at 463 to an aggregation and scheduling module 466 which accumulates the translated and encoded data destined for multiple remote display devices 401, and schedules the data for eventual distribution by the connectivity provider 454. For example, the data forming a five day forecast for a given location may be transmitted once every 15 minutes during the day, and once every hour at night.

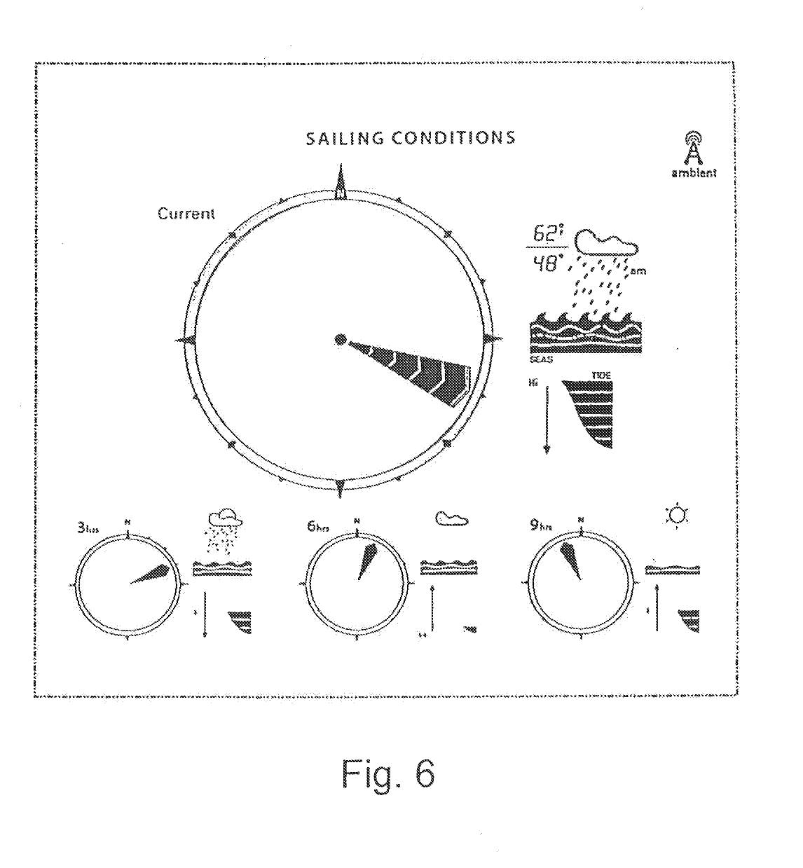

FIGS. 5 and 6 show alternative layouts for presenting data at a plurality of receiving display locations which is simulcast to each location from a remote information server. FIG. 5 shows an LCD panel which, when used with suitable signal processing circuitry, displays a nine day weather forecast in nine different areas, each of which includes an icon for displaying weather conditions similar to the icons seen at 201 in FIG. 2, in combination with numerals which indicate the forecast high and low temperatures for that day. Note that FIG. 5 employs digits to display ambient information, demonstrating that embodiments of this application can, in some cases, include terse textural and/or digital components (letters and/or numbers) as well as symbols, icons, variable length bars, variable position hands or pointers, etc.

FIG. 6 is a further example forecast which is of particular value to sailors, providing the wind direction, weather conditions including high and low temperatures, the sea conditions, and the tide level for the current time, and for 3, 6 and 9 hours in advance.

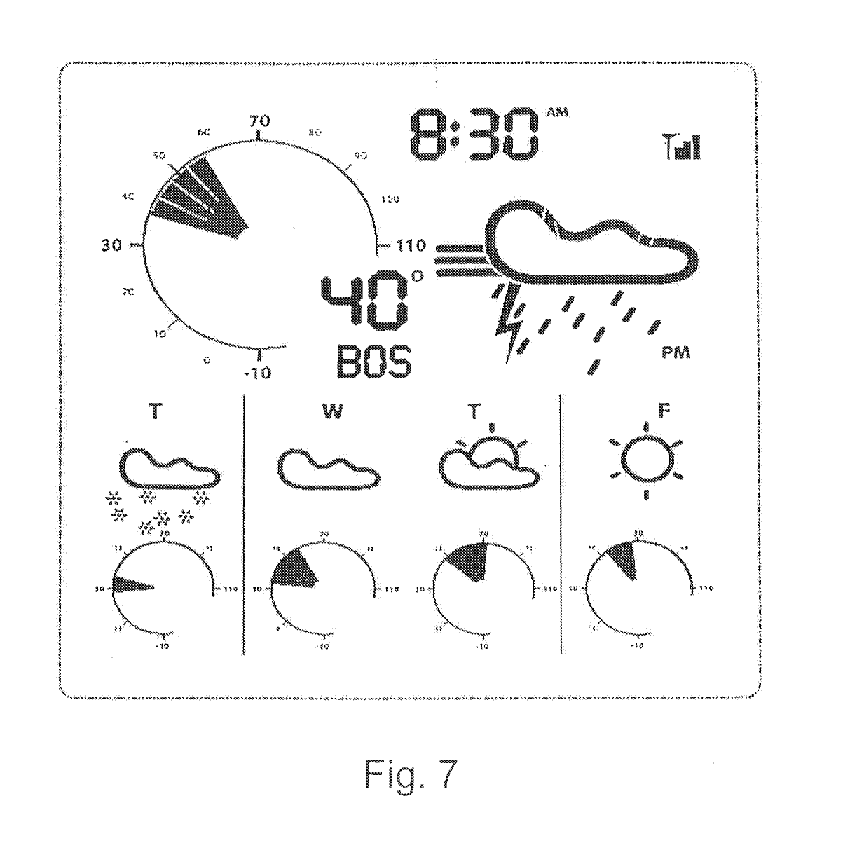

FIGS. 7 and 8 show still further alternative display layouts which provide an iconic representation of current weather conditions at the top, and four smaller areas showing conditions over the next four days. In FIG. 7, the low to high temperature range for each day is shown by a circular icon in which pie shaped wedge segments are turned on or off to show the temperature range, whereas in FIG. 8, numeric text characters displaying the low and high temperatures are displayed.

Conclusion

It is to be understood that the methods and apparatus which have been described above are merely illustrative applications of the principles of the invention. Numerous modifications may he made by those skilled in the art without departing from the true spirit and scope of the invention.

What is claimed is:

1. Apparatus for displaying information transmitted from a remote location comprising, in combination:
a transmitter for broadcasting an information bearing data signal to each of a plurality of receiving locations, and a
a display device located at each of said receiving locations for displaying a representation of said information bearing signal at each of said locations simultaneously, said display device comprising:
a receiver for detecting said information bearing signal broadcast by said transmitter to produce a received data signal,
signal processing means coupled to said receiver for converting said received data signal into a plurality of control signals, and
a mosaic of separately controlled non-uniform visual elements connected to receive said control signals from said signal processing means, the appearance of each of said visual elements being controlled by one of said control signals.

2. Apparatus for displaying information transmitted from a remote location as set forth in claim 1 wherein said transmitter and receiver respectively send and receive data packets via a radio transmission link.

3. Apparatus for displaying information transmitted from a remote location as set forth in claim 2 wherein said radio transmission link is part of a radio paging system.

4. Apparatus for displaying information transmitted from a remote location as set forth in claim 2 wherein said mosaic of separately controlled visual elements is formed by a display panel in which said visual elements receive and assume a visual state representative of said control signals.

5. Apparatus for displaying information transmitted from a remote location as set forth in claim 4 wherein said display panel is a liquid crystal display panel comprising visual elements controlled by said control signals.

6. Apparatus for displaying information transmitted from a remote location as set forth in claim 5 wherein said radio transmission link is part of a radio paging system.

7. Apparatus for displaying information transmitted from a remote location as set forth in claim 2 wherein said display device further includes a data memory for storing a plurality of data signals produced from different information bearing signals broadcast and received at different times and wherein the appearance of said visual elements is representative of said plurality of data signals.

8. Apparatus for displaying information transmitted from a remote location as set forth in claim 4 wherein said display panel forms a mosaic of separately controlled visual elements is formed by a display device selected from the group comprising: a liquid crystal display, an electronic ink display, and an electrophoretic display.

9. Apparatus for displaying information transmitted from a remote location as set forth in claim 8 wherein the visual appearance of each of said visual elements of said display panel is controlled by one of said control signals.

10. Apparatus for displaying information transmitted from a remote location as set forth in claim 9 wherein said radio transmission link is part of a radio paging system.

11. Apparatus for displaying information transmitted from a remote location as set forth in claim 7 wherein said radio transmission link is part of a radio paging system.

12. Apparatus for displaying information transmitted from a remote location as set forth in claim 1 wherein said mosaic of separately controlled visual elements is formed by a liquid crystal display panel in which said visual elements are formed by electrodes connected to receive said control signals.

13. Apparatus for displaying information transmitted from a remote location as set forth in claim 12 wherein the reflectivity of each of said visual elements of said liquid crystal display panel is controlled by one of said control signals.

14. Apparatus for displaying information transmitted from a remote location as set forth in claim 12 wherein said radio transmission link is part of a radio paging system.

15. Apparatus for displaying information transmitted from a remote location as set forth in claim 1 wherein said display device further includes a data memory for storing a plurality of data signals produced from different information bearing signals broadcast and received at different times and wherein the appearance of said visual elements is representative of said plurality of data signals.

16. Apparatus for displaying information transmitted from a remote location as set forth in claim 15 wherein said radio transmission link is part of a radio paging system.

17. Apparatus for displaying information transmitted from a remote location as set forth in claim 1 wherein said information bearing data signal conveys a weather forecast.

18. Apparatus for displaying information transmitted from a remote location as set forth in claim 18 wherein said information bearing data signal conveys a weather forecast for a particular geographic location.

19. Apparatus for displaying information transmitted from a remote location as set forth in claim 18 wherein said information bearing data signal conveys a weather forecast for each of several days for a particular geographic location.

20. Apparatus for displaying information transmitted from a remote location as set forth in claim 1 wherein said display device is designated by a unique identification code and wherein apparatus includes means for transmitting specific information via said network to a specific display device using said unique identification code.

21. Apparatus for displaying information transmitted from a remote location as set forth in claim 1 including means for transmitting data or programs to a specific display device from said transmitter to said specific display device to alter the manner in which said display device visually displays a representation of data received from said transmitter.

22. Apparatus for displaying information transmitted from a remote location as set forth in claim 1 including means for transmitting a service type code from said transmitter to said display device and means included in said display device for thereafter receiving and responding to data associated with said service type code.
